(19) United States
(12) Patent Application Publication
(10) Pub. No.: US 2014/0360344 A1
(43) Pub. Date: Dec. 11, 2014

(54) HIGH PERFORMANCE THERMOPLASTIC COMPOSITE LAMINATES AND COMPOSITE STRUCTURES MADE THEREFROM

(71) Applicant: Gordon Holdings, Inc., Englewood, CO (US)

(72) Inventors: Edward D. Pilpel, Avon, CT (US); Jonathan Spiegel, Aurora, CO (US); Benjamin D. Pilpel, Lone Tree, CO (US); Bruno Reich, Montrose, CO (US)

(73) Assignee: Gordon Holdings, Inc., Englewood, CO (US)

(21) Appl. No.: 14/213,153

(22) Filed: Mar. 14, 2014

Related U.S. Application Data
(63) Continuation of application No. 14/071,282, filed on Nov. 4, 2013.
Application No. 14/071,282 is a continuation of application No. 14/071,324, filed on Nov. 4, 2013.
(60) Provisional application No. 61/818,510, filed on May 2, 2013.
(60) Provisional application No. 61/791,595, filed on Mar. 15, 2013.

(51) Int. Cl. B32B 27/28; B32B 27/06; F41H 5/04; B32B 5/18; H01M 2/02; B32B 27/30; B32B 5/12

(52) U.S. Cl. CPC B32B 27/281; B32B 27/304; B32B 27/065; B32B 5/12; B32B 5/18; B32B 27/286; B32B 27/288; H01M 2/0287; F41H 5/0478
USPC 89/36.02; 428/421; 428/319.7; 428/114; 428/318.6; 428/34.5; 428/419; 428/426; 428/435; 429/100; 138/140; 156/60

(57) ABSTRACT

A fire resistant composite laminate includes a thermoplastic matrix material reinforced with fibers embedded in the matrix of the composite laminate, wherein the thermoplastic matrix material of the fire resistant composite laminate includes polyvinylidene fluoride (PVDF).

### CROSS-REFERENCE TO RELATED APPLICATIONS

This patent application claims priority benefit under 35 U.S.C. §119(e) of copending, commonly owned U.S. Provisional Patent Application Ser. No. 61/818,510, filed on May 2, 2013, entitled “High Performance Thermoplastic Composite Laminates and Composite Structures Made Therefrom” (Attorney Docket No. 1017-0049), and U.S. Provisional Patent Application Ser. No. 61/791,595, filed on Mar. 15, 2013, entitled “High Performance Thermoplastic Composite Laminates and Composite Structures Made Therefrom” (Attorney Docket No. 1017-0048), and under 35 U.S.C. §120 of U.S. Non-Provisional application Ser. No. 14/071,282 was filed on Nov. 4, 2013, entitled “High Strength, Light Weight Composite Structure, Method of Manufacture and Use Thereof” (Attorney Docket No. 1017-0046-1), which claims the benefit of U.S. Provisional Application Ser. No. 61/789,177 filed on Mar. 15, 2013, and also claims the benefit of U.S. Non-Provisional application Ser. No. 14/071,324 was filed on Nov. 4, 2013, entitled “Composite Laminate, Method of Manufacture and Use Thereof” (Attorney Docket No. 1017-0037-1) which claims priority of U.S. Provisional Application Ser. No. 61/722,448, filed on Nov. 5, 2012, the contents of each afore-mentioned applications are incorporated by reference herein in their entireties.

### TECHNICAL FIELD

The present disclosure is generally directed to composite laminates and composite structures made therefrom, and particularly directed to high performance thermoplastic composite laminates and composite structures made therefrom, and to their methods of manufacture.

### BACKGROUND

Application of composite materials has often been limited to components that experience low to moderate structural loads. However, there is a need for light weight, lower cost, high performance composites that can meet aerospace and general transportation needs in terms of, e.g., corrosion resistance, flame resistance, smoke and/or toxicity requirements. Additionally, there is such a need in industries concerning power generation, construction, land and sea shipping, as well as in industries concerning armor or ballistic materials for, e.g., vehicles and personnel, particularly with respect to fire retardancy requirements.

Embodiments of the invention overcome the afore-referenced problems and address the foregoing industrial needs.

### SUMMARY

According to aspects illustrated herein, there is provided a fire resistant composite laminate comprising a thermoplastic matrix material reinforced with fibers embedded in the matrix of the composite laminate. The thermoplastic matrix material of the fire resistant composite laminate comprises polyvinylidene fluoride (PVDF).

According to further aspects illustrated herein, there is provided a fire resistant composite laminate comprising a polymeric matrix material reinforced with fibers embedded in the matrix of the composite laminate. The polymeric matrix material of the fire resistant composite laminate comprises at least one of polyvinylidene fluoride (PVDF), polyether ether ketone (PEEK), polyphenylene sulfide (PPS) and polyetheramide (PEI).

According to still further aspects illustrated herein, there is provided a fire retardant ballistic panel comprising a fire resistant composite laminate. The composite laminate comprises a fire resistant polymeric matrix material reinforced with fibers embedded in the matrix of the composite laminate, wherein the fire retardant ballistic panel achieves at least one protection level against a projectile as defined by NIJ Standard Armor grades II-A, II, III-A, III and IV when the projectile is directed at the panel.

According to further aspects illustrated herein, there is provided a fire retardant ballistic panel having a first face and a second face and comprising: a strike face portion comprising a first plurality of plies each comprising fibers in a first polymeric matrix material comprising a first fire retardant resin. The fire retardant ballistic panel further comprises a support portion adjacent to the strike face portion, the support portion comprising a second plurality of plies each comprising fibers in a second polymeric matrix material comprising a second fire retardant resin, wherein each ply is bound to an adjacent ply.

### BRIEF DESCRIPTION OF THE DRAWINGS

FIG. 1 is a schematic illustration of a perspective view of a high performance composite structure, according to embodiments, and comprising a core;

FIG. 1A is a schematic illustration of an expanded view of the high performance composite structure of FIG. 1;

FIG. 2 is a schematic illustration of a perspective view of the core of FIG. 1, according to embodiments;

FIG. 3 is a schematic illustration of a non-limiting example of layers/plies, which could be included as a laminate of the composite structure, according to embodiments;

FIG. 4 is a general schematic depiction of an apparatus used to produce, e.g., a composite laminate of the composite structure, according to embodiments;

FIG. 5 is a rear view of a refrigerated trailer including a composite structure and/or laminate, according to embodiments;

FIG. 6 is a perspective view of an air cargo container including a composite structure and/or laminate, according to embodiments;

FIG. 7 is a perspective view of a rail cargo container including a composite structure and/or laminate, according to embodiments;

FIG. 8 is a perspective view of an intermodal container including a composite structure and/or laminate, according to embodiments;

FIG. 9 depicts a battery case comprising the composite structure and/or composite laminate, according to embodiments;

FIG. 10 depicts a battery box comprising the composite structure and/or laminate, according to embodiments; and

FIG. 11 depicts a schematic partly cross-sectional perspective view of a fire retardant ballistic panel according to embodiments.

### DETAILED DESCRIPTION

The inventors herein describe, according to embodiments, high performance thermoplastic composite laminates and high performance composite structures made therefrom, and methods of makings such laminates and structures. Such high strength laminates and structures provide a much needed solution as the inventors have further determined that certain resins that may meet some needs of, e.g., aerospace applications, are costly and difficult to process, generally requiring special processes for the production of the resin, as well as post processing of the resins to make a final product. For example, commodity olefin resins typically lose their properties when doped with fire retardant additives, often to a point of significant reduction in mechanical properties of a resultant structure. Moreover, such materials do not meet typical fire retardant requirements of aerospace and other transportation industries. Thus, according to embodiments, the inventors have determined how to, e.g., couple the performance of high performing fire retardant resins with high strength fibers in a thermoplastic matrix resulting in a high performance composite from a mechanical property standpoint, as well as affording corrosion resistance, and no fire, smoke and toxicity capability (i.e., providing significant resistance/retardance to fire, smoke and toxics), thereby meeting industrial needs.

As will be described in further detail below, according to embodiments, disclosed is a composite material comprised of continuous fiber reinforced thermoplastic material that can be readily manufactured, provide high strength-to-weight ratio, impact resistance, fatigue resistance, chemical resistance, temperature resistance, flame resistance, and/or low or no toxicity, as well as other desirable properties for use in, e.g., commercial applications. As also described in further detail below, embodiments advantageously incorporate the use of high strength fibers, such as “E” and “S” fiberglass and polyvinylidene fluoride (PVDF) resin to meet such requirements in forms such as, e.g., a high performance single tape laminate, plied laminate, and/or sandwiched panel, to provide, e.g., a non-fire, non-smoke and non-toxicity composite product that can meet, e.g., aerospace requirements. It has also been determined that materials such as carbon, aramide, basalt and boron are suitable and advantageous to be incorporated in the composite materials disclosed herein.

The inventors have further determined that the use of unidirectional tapes for the construction of the laminates disclosed herein can improve the mechanical performance of the composite over, e.g., traditional woven laminates. Moreover, the use of fibers, such as fiberglass can displace (e.g., 50% to 85% by weight) the amount of relatively high cost resin (e.g., PVDF) employed for smoke, flame and toxicity requirements with less costly materials, and can provide desired mechanical properties. However, it is further noted that the laminates disclosed herein can provide strength and fire reduction qualities in tape laminated form, as well as in laminates of plied configurations, and so forth, as further described below. In general, according to embodiments, the high strength reinforced thermoplastic materials and structures disclosed herein comprise a combination of thermoplastic matrix materials, high strength reinforcing fibers, and possibly other reinforcing materials, as needed.

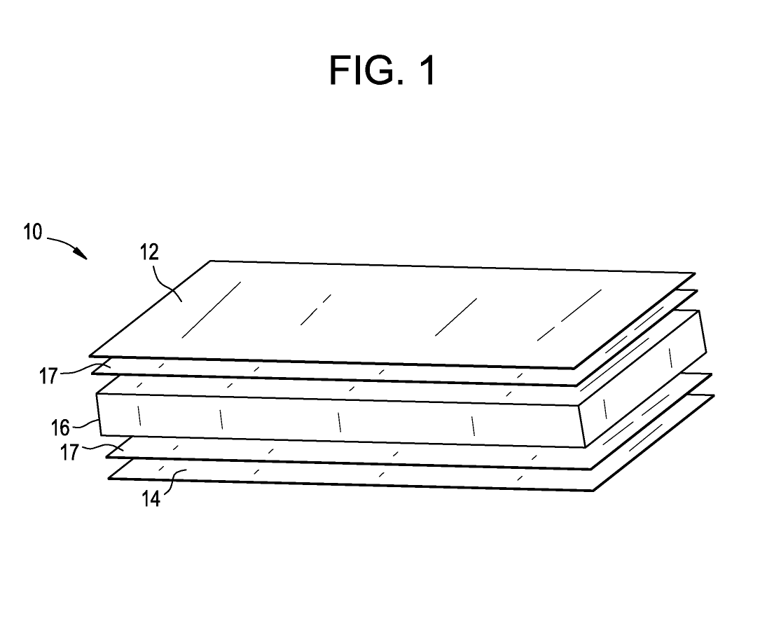

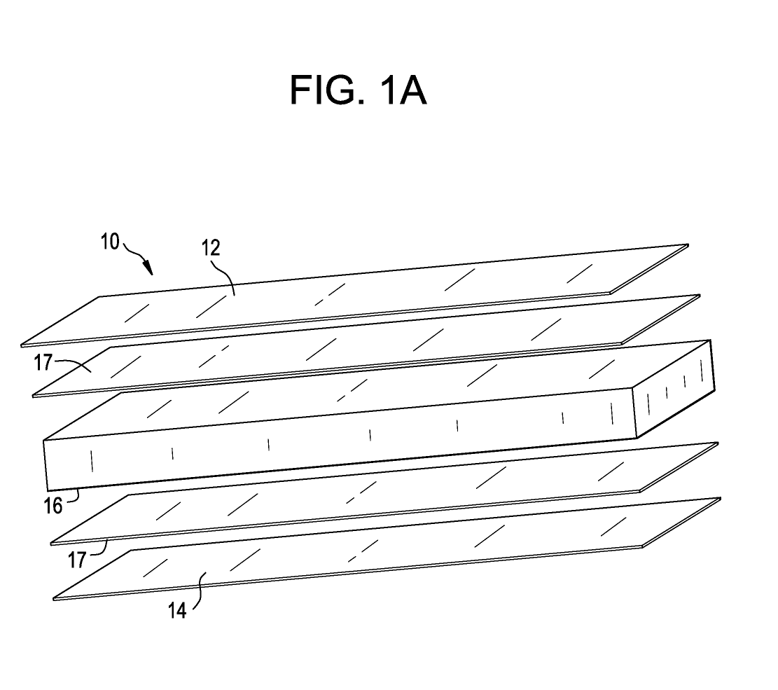

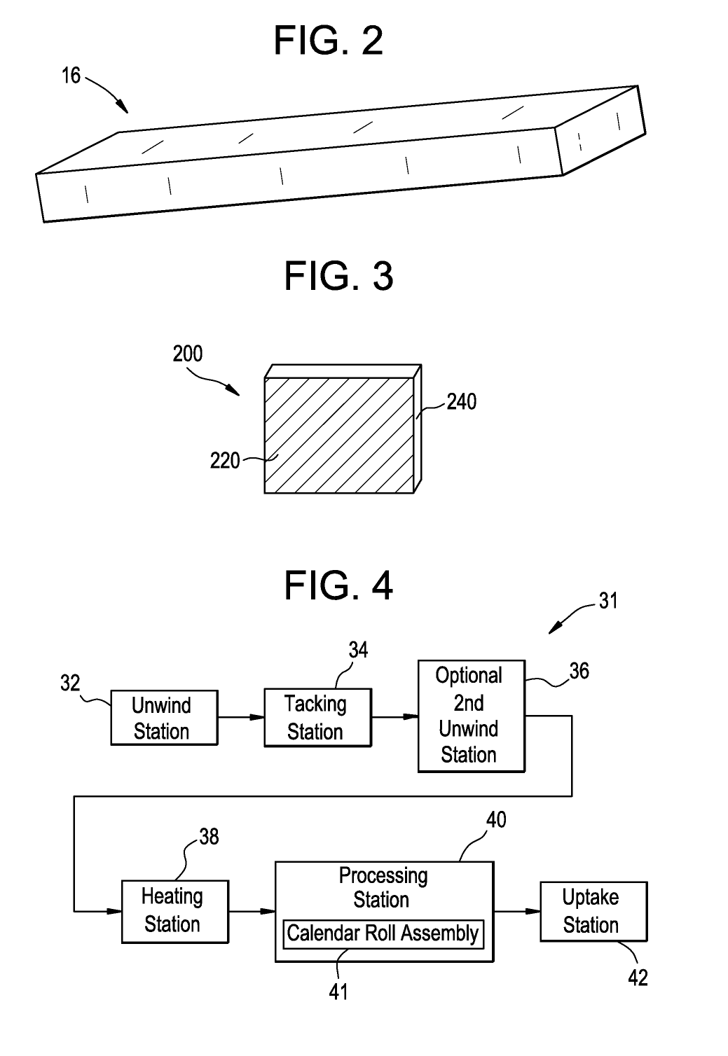

Referring now to the figures, one aspect disclosed herein is directed to a composite structure (10), as shown in FIGS. 1 and 1A, comprising a first outer layer/skin (12); a second outer layer/skin (14); and a core (16) sandwiched between the first outer layer (12) and the second outer layer (14). It is noted that the core (16) need not be directly positioned against the first outer layer (12) and/or the second outer layer (14). For example, as shown in FIGS. 1 and 1A, at least one intermediate layer/skin (17) could also be positioned between the first outer layer (12) and the second outer layer (14). Thus, according to embodiments, the core (16) can be sandwiched between, e.g., two intermediate layers (17). More or less layers (17) layers could be employed as desired. As a further alternative, no intermediate layer (17) could be employed.

It is initially noted that while the structure (10) shown in FIGS. 1 and 1A is depicted as a composite “sandwich panel,” substantially rectangular in shape, the configurations of the composite structure (10) are not so limited, as the composite structure (10) can be formed into any suitable shape, size and thickness depending upon the end use article, and so forth. Thus, the composite structure (10) including the layers/e.g., laminates (12), (14) and (17) therein, as well as the core (16) can be Rained into any suitable shape, size, thickness, dimensions, and so forth, and into any suitable article/product configurations. Further details and examples of such articles are set forth below following the compositional information, according to embodiments.

The core (16) of FIGS. 1 and 1A comprises a suitable material, typically foam. According to an embodiment, the foam comprises polyvinylidene fluoride (PVDF) foam, e.g., Zotek brand PVDF foam. It is noted, however, that according to embodiments the core (16) can comprise any suitable material including the materials described herein for, e.g., layers (12), (14) and (17), and in any combination.

Regarding the materials for the first outer layer (12), the second outer layer (14) and the at least one intermediate layer (17), as well as the assembly and construction thereof, the following non-limiting materials and processes are noted. While particular thermoplastic materials are referenced below, it is noted that embodiments of the composite structure (10), including the first and second outer layers (12, 14) and intermediate layer(s) (17), can be made of out any suitable fiber reinforced thermoplastic resins, with and/or without further reinforcements, as well as include any suitable thermoplastic coverings/layers.

According to an embodiment, the “sandwich panel” (10) depicted in FIGS. 1 and 1A can comprise layers or multiple layers of laminates (e.g., layers 12 and/or 14 and/or 17) applied to, e.g., bonded thereto with use of a suitable adhesive, the opposing faces of a sheet of expanded thermoplastic foam (e.g., core 16). In an embodiment, the layer or layers of laminates applied to the opposing faces may be comprised of fiber-reinforced thermoplastic tapes having, e.g., unidirectional and/or multiaxial fiber alignments based on the desired properties of the final product. Thus, according to a particularly suitable embodiment, disclosed is a panel comprising high strength layers/skins (12, 14) comprising, e.g., a high strength, continuous fiber (e.g., fiberglass) reinforced PVDF resin matrix, and a core (16) comprising a PVDF foam. Incorporation of PVDF material in the constructions disclosed herein desirably can impart fire resistance/retardance properties to the resultant structures and products.

According to embodiments, at least one of the first outer layer (12), the second outer layer (14) and the intermediate layer(s) (17) comprises a plurality of composite plies including at least a first composite ply and a second composite ply, the first composite ply and the second composite ply each comprising a plurality of fibers in a thermoplastic matrix; the plurality of composite plies being bonded together to form a composite laminate. According to some embodiments, all of the first outer layer (12), the second outer layer (14), the intermediate layer(s) (17) comprise such features. At least one of the layers, (12), (14), (17) and core (16) comprise PVDF, according to embodiments.

The composite laminate of at least one of the first outer layer (12), the second outer layer (14) and the intermediate layer(s) (17), could comprise one or more composite plies each, and often at least two composite plies, e.g., a first composite ply and a second composite ply, bonded together, according to embodiments. Each ply comprises a plurality of fibers. The plurality of fibers of each of the first composite ply and the second composite ply are impregnated with a thermoplastic matrix material.

According to embodiments, the thermoplastic matrix material may comprise any material or combination of materials of a thermoplastic nature suitable for the application including, but not limited to polyvinylidene fluoride (PVDF), which can desirably impart fire resistance properties to the resultant composite materials, polyamide (nylon), polyethylene, polypropylene, polyethylene terephthalate, polyphenylene sulfide, polyether ether ketone (PEEK), polyphenylene sulfide (PSS), polyetheramide (PEI), fluoro polymers in general and other engineering resins, other thermoplastic polymers and/or combinations thereof, e.g., exhibiting desired properties.

In an embodiment, the plurality of fibers in the first composite ply are substantially parallel to each other, and the plurality of fibers in the second composite ply are substantially parallel to each other. Thus, the fibers of each ply are longitudinally oriented (that is, they are aligned with each other), and continuous across the ply, according to an embodiment. A composite ply is sometimes referred to herein as a ply or sheet and characterized as “unidirectional” in reference to the longitudinal orientation of the fibers, according to embodiments.

In further accordance with embodiments disclosed herein, the plurality of fibers in the first composite ply are disposed cross-wise (transverse) to the plurality of fibers in the second composite ply. For example, the fibers in the first composite ply are disposed cross-wise to the plurality of fibers in the second composite ply at an angle of greater than about 0 degrees to about 90 degrees, specifically at an angle of about 15 degrees to about 75 degrees. It is further noted that 0 degrees to about 90 degrees also could be employed, according to embodiments.

Additionally, the plurality of fibers in the first composite ply are the same or different from the plurality of fibers in the second composite ply, according to embodiments. Thus, various types of fibers, including different strength fibers, are used in a composite ply, according to embodiments. Example fibers include E-glass and S-glass fibers. E-glass is a low alkali borosilicate glass with good electrical and mechanical properties and good chemical resistance. Its high resistivity makes E-glass suitable for electrical composite laminates. The designation “E” is for electrical.

S-glass is a higher strength and higher cost material relative to E-glass. S-glass is a magnesia-alumina-silicate glass typically employed in aerospace applications with high tensile strength. Originally, “S” stood for high strength. Both E-glass and S-glass are particularly suitable fibers for use with embodiments disclosed herein.

E-glass fiber may be incorporated in a wide range of fiber weights and thermoplastic polymer matrix material. The E-glass ranges from about 10 to about 40 ounces per square yard (oz./sq. yd.), specifically about 19 to about 30, and more specifically about 21.4 to about 28.4 oz./sq. yd. of reinforcement, according to embodiments. As a non-limiting example, a minimum weight of a cross (X) ply could be approximately 18 oz./sq. yd. of composite. At 70% fiber by weight, the reinforcement would be 70% of 18 oz.

The quantity of S-glass or E-glass fiber in a composite ply optionally accommodates about 40 to about 90 weight percent (wt. %) thermoplastic matrix, specifically about 50 to about 85 wt. % and, more specifically, about 60 to about 80 wt. % thermoplastic matrix in the ply, based on the combined weight of thermoplastic matrix plus fiber.

Other fibers may also be incorporated, specifically in combination with E-glass and/or S-glass, and optionally instead of E- and/or S-glass. Such other fibers include ECR, A and C glass, as well as other glass fibers; fibers formed from quartz, magnesia alumuninosilicate, non-alkaline aluminoborosilicate, soda borosilicate, soda silicate, soda lime-aluminosilicate, lead silicate, non-alkaline lead boroalumina, non-alkaline barium boroalumina, non-alkaline zinc boroalumina, non-alkaline iron aluminosilicate, cadmium borate, alumina fibers, asbestos, boron, silicone carbide, graphite and carbon such as those derived from the carbonization of polyethylene, polyvinylalcohol, saran, aramid, polyamide, polybenzimidazole, polyoxadiazole, polyphenylene, PPR, petroleum and coal pitches (isotropic), mesophase pitch, cellulose and polyacrylonitrile, ceramic fibers, metal fibers as for example steel, aluminum metal alloys, and the like.

Where relatively high performance is required and cost justified, high strength organic polymer fibers formed from an aramid exemplified by Kevlar or various carbon fibers may be used. High performance, unidirectionally-oriented fiber bundles generally have a tensile strength greater than 7 grams per denier. These bundled high-performance fibers may be any one of, or a combination of, aramid, extended chain ultra-high molecular weight polyethylene (UHMWPE), poly[p-phenylene-2,6-benzobisoxazole] (PBO), and poly[diimidazo pyridinylene (dihydroxy)phenylene]. The use of these very high tensile strength materials is particularly useful for composite panels having added strength properties.

Accordingly, fiber types known to those skilled in the art can be employed without departing from the broader aspects of the embodiments disclosed herein. For example, aramid fibers such as those marketed under the trade names Twaron, and Technora; basalt, carbon fibers such as those marketed under the trade names Toray, Fortafil and Zoltek; Liquid Crystal Polymer (LCP), such as, but not limited to, LCP marketed under the trade name Vectran. Based on the foregoing, embodiments also contemplate the use of organic, inorganic and metallic fibers either alone or in combination.

The composite plies optionally include fibers that are continuous, chopped, random comingled and/or woven, according to embodiments. In particular embodiments, composite plies as described herein contain longitudinally oriented fibers to the substantial exclusion of non-longitudinally oriented fibers.

In addition, optional additional materials, such as foams, metals (e.g., aluminum steel, other ferrous and/or non-ferrous metals, and so forth), plastics, epoxides, composites, chemicals and/or other suitable materials may be used as reinforcements, additives and/or inserts to impart, e.g., specific mechanical, dimensional or other properties either uniformly throughout the material, or in a specific region of a thermoplastic composite structures and/or laminates disclosed herein, according to embodiments. Thus, it is noted that combinations of any of the fibers, optional additional materials, reinforcements, and so forth, can be employed in the composite materials, laminates, and structures disclosed herein, and in any suitable amounts and in any desired combination with the afore-referenced optional additional materials.

Moreover, the use of continuous reinforcing fibers, e.g., fiber lengths equivalent to the length of the material or structure, in the construction of composite materials can provide greater strength when measured parallel to the direction of fiber orientation. The ability to maintain, e.g., consistent fiber alignment and tension, as well as obtaining thorough impregnation of reinforcing fibers with the desired matrix material, can result in a composite material, e.g., structure/laminate exhibiting enhanced physical properties.

Since fibers within a composite ply are longitudinally oriented, according to embodiments, a composite ply in a composite laminate can be disposed with the fibers in a specified relation to the fibers in one or more other composite plies of the laminate.

In a particular embodiment, fibers within a tape or ply are substantially parallel to each other, and the composite laminate comprises a plurality of plies with the fibers of one ply being disposed cross-wise in relation to the fibers in an adjacent ply, for example, at an angle of up to about 90 degrees relates to the fibers in the adjacent ply. The fibers are evenly distributed across the ply, according to embodiments. Other examples include tape comprising fibers disposed in a thermoplastic matrix, and cross-ply tapes or laminates, e.g., material comprising two plies of fibers in a thermoplastic matrix material with the fibers in one ply disposed at about 90 degrees to the fibers in the other ply.

The thermoplastic matrix of one or more plies of the composite laminate described herein for use as the material for at least one of the first outer layer (12), second outer layer (14) comprises a thermoplastic matrix comprising, e.g., PVDF, according to embodiments. Non-limiting examples of thermoplastic materials include, but are not limited, to polyamide (nylon), polyethylene, polypropylene, polyethylene terephthalate, polyphenylene sulfide, polyetherketone, combinations thereof, and so forth. Also, as further described below, polyvinylidene fluoride (PVDF) alone or in any combination with the other matrix constituents noted herein may be employed in the matrix and such an incorporation of this PVDF material can impart fire resistance to the resultant structure.

It has also been determined, however, that the use of polyethylene in the thermoplastic matrix material can results in a composite laminate having improved puncture resistance with less weight per unit of puncture protection compare to, e.g., polypropylene based composite laminates. Polyethylene also is more consistent in pricing than polypropylene, which tends to be highly variable in price due, in part, to the complex manufacturing processes needed to produce the propylene monomer. As described in further detail below, because the weight of a polyethylene composite laminate is less than, e.g., a polypropylene composite laminate, more cargo can be carried in a given container made or lined with such a material, which improves fuel efficiency and cost effectiveness in, e.g., trucks, railcars and ships in which they are used.

According to embodiments, copolymers of polyethylene and polypropylene are also useful as the thermoplastic matrix. For example, copolymers with more than about 50 wt. % polyethylene are useful with additions of polypropylene of up to about 50 wt. %, depending upon the application and property requirements thereof.

In further embodiments, the thermoplastic matrix of one or more of the plies comprises coextruded polyethylene and polyethylene terephthalate (sometimes written as poly(ethylene terephthalate)), commonly abbreviated as PET, in any suitable weight percent combinations. For example, PET polymers that are employed, according to embodiments, include thermoplastic PET polymer resins used in synthetic fibers; beverage, food and other liquid containers; thermoforming applications; and engineering resins in combination with glass fiber. PET homopolymers may be modified with comonomers, such as CHDM or isophthalic acid, which lower the melting temperature and reduce the degree of crystallinity of PET. Thus, the resin can be plastically formed at lower temperatures and/or with lower applied force. These PET homopolymers and copolymers are coupled with an optional release film for, e.g., later painting and such optional layers can also be laminated to the base composite structure, according to embodiments.

Accordingly, the polymeric matrix material for use in various embodiments disclosed herein comprises a polyethylene thermoplastic polymer. Thermoplastic loading by weight can vary depending upon the physical property requirements of the intended use of the product. It is noted that polyethylene is classified into different categories, which are mostly based on density and branching, and the mechanical properties of the polyethylene depend on variables such as the extent and type of branching, crystal structure and molecular weight. Particular examples include low-density polyethylene (LDPE), ultra-high-molecular-weight polyethylene (UHMWPE), ultra-low-molecular-weight polyethylene (ULMWPE or PE-WAX), high-molecular-weight polyethylene (HMWPE), high-density polyethylene (HDPE), high-density cross-linked polyethylene (HDXLPE), cross-linked polyethylene (PEX or XLPE), medium-density polyethylene (MDPE), linear low-density polyethylene (LLDPE), very-low-density polyethylene (VLDPE), and combinations thereof. Particularly useful types of polyethylene include HDPE, LLDPE and especially LDPE, as well as combinations thereof. Further details regarding particular properties of various types of polyethylene for use in the thermoplastic matrix described herein, according to embodiments, are set forth below.

LDPE has a density range of 0.910-0.940 g/cm³ and a high degree of short and long chain branching. Accordingly, the chains typically do not tightly pack into the crystal structure. Such material does exhibit strong intermolecular forces as the instantaneous-dipole induced-dipole attraction is less. This results in a lower tensile strength and increased ductility. LDPE is created by free radical polymerization. The high degree of branching with long chains gives molten LDPE unique and desirable flow properties.

UHMWPE is a polyethylene with a molecular weight in the millions, typically between about 3 and 6 million. The high molecular weight makes UHMWPE a very tough material, but can result in less efficient packing of the chains into the crystal structure as evidenced by densities of less than high density polyethylene (for example, 0.930-0.935 g/cm³). UHMWPE can be made through any catalyst technology, with Ziegler catalysts being typical. As a result of the outstanding toughness and cut of UHMWPE, wear and excellent chemical resistance, this material is useful in a wide range of diverse applications.

HDPE has a density of greater than or equal to 0.941 g/cm³. HDPE has a low degree of branching and thus strong intermolecular forces and tensile strength. HDPE can be produced by chromium/silica catalysts, Ziegler-Natta catalysts and/or metallocene catalysts. The lack of branching is ensured by an appropriate choice of catalyst (for example, chromium catalysts or Ziegler-Natta catalysts) and reaction conditions.

PEX (also denoted as XLPE) is a medium to high-density polyethylene containing cross-link bonds introduced into the polymer structure, which change the thermoplast into an elastomer. High-temperature properties are thus improved, flow reduced and chemical resistance enhanced.

MDPE has a density range of 0.926-0.940 g/cm³. MDPE can be produced with use of chromium/silica catalysts, Ziegler-Natta catalysts and/or metallocene catalysts. MDPE has good shock and drop resistance properties. This material also is less notch sensitive than HDPE and also exhibits better stress cracking resistance than HDPE.

LLDPE has a density range of 0.915-0.925 g/cm³. LLDPE is a substantially linear polymer with a significant number of short branches, commonly made by copolymerization of ethylene with short-chain alpha-olefins (for example, 1-butene, 1-hexene and 1-octene). LLDPE has higher tensile strength than LDPE, and exhibits higher impact and puncture resistance than LDPE. LDPE also exhibits properties such as toughness, flexibility and relative transparency.

VLDPE has a density range of 0.880-0.915 g/cm³. VLDPE is a substantially linear polymer with high levels of short-chain branches, commonly made by copolymerization of ethylene with short-chain alpha-olefins (for example, 1-butene, 1-hexene and 1-octene). VLDPE is typically produced using metallocene catalysts due to, for example, the greater co-monomer incorporation exhibited by these catalysts. VLDPEs also can be used as impact modifiers when blended with other polymers.

In addition to the particular polymers noted above, copolymers/combinations of the any of the foregoing are contemplated for use according to embodiments disclosed herein. As a further non-limiting example, in addition or alternative to copolymerization with alpha-olefins, ethylene (or polyethylene) can also be copolymerized with a wide range of other monomers and ionic compositions that create ionized free radicals. Examples include vinyl acetate, the resulting product being ethylene-vinyl acetate copolymer (EVA), and/or suitable acrylates. Additionally, the thermoplastic matrix can comprise polyvinylidene fluoride (PVDF) alone or in any combination with the other matrix constituents noted herein to impart fire resistance to the resultant structure.

According to embodiments disclosed herein, the thermoplastic matrix of one or more composite plies of the composite laminates described herein comprises polyethylene, alone or in combination with other polymers/copolymers/constituents, e.g., PVDF. For instance, polyethylene/PVDF can be employed as the matrix material along with a high molecular weight thermoplastic polymer, including but not limited to, polypropylene, nylon, PEI (polyetherimide) and copolymers thereof, as well as combinations of any of the foregoing.

According to embodiments, a composite ply contains about 60 to about 10 wt. % polymeric matrix, specifically about 50 to about 10 wt. %, and more specifically about 40 to about 15 wt. %. Other exemplary ranges include about 40 to about 20 wt. % and about 30 to about 25 wt. %. It is noted that the foregoing weight percents are the weight percents of the polymeric matrix material of the ply, by weight of polymeric matrix material plus fibers.

In an exemplary embodiment, the fiber content in one or more composite plies is greater than about 50 wt. % (based upon weight of polymeric matrix plus fibers of the ply), specifically up to about 85 wt. %, and while various types of fibers are suitable, as described above, glass fibers are particularly suitable to achieve stiffness.

In a further exemplary embodiment, a composite laminate as described herein comprises at least a first ply and a second ply that are bonded together with their respective fibers in transverse relation to each other, and the first ply contains fibers that are different from the fibers in the second ply, wherein the matrix of one or both of the first and second plies comprises polyethylene. Thus, the composite laminate comprises at least two different kinds of fibers. In other words, fibers in at least a first composite ply are disposed in transverse relation to different fibers in an adjacent second composite ply, optionally at 90 degrees to the different fibers in the adjacent second composite ply. For ease of expression, a first composite ply and a second composite ply so disposed are sometimes described herein as being in transverse relation to each other (optionally at 90 degrees to each other) without specific mention of the fibers in each of the plies.

The phrase “different fibers” should be broadly construed to mean that the composite laminate includes least two composite plies whose fibers are made from two different materials or different grades of the same material. For example, as described in further detail below with respect to uses of the composite laminates described herein, one face of panel that comprises a composite laminate could be formed using Kevlar 129 fiber while the rear or back portion of the panel could be formed using a higher performing material.

Optionally, a composite laminate may also contain a composite ply disposed in parallel to an adjacent composite ply, particularly an adjacent ply that contains the same kind of fibers as in the first composite ply. The matrix material of at least one of ply, specifically all plies, comprises polyethylene. In addition, the matrix material can vary from ply-to-ply and can be in the form of different thermoplastics, polymers and combinations thereof. Therefore, a portion of a composite laminate incorporating a first fiber type can be formed in part by stacking individual composite plies one-on-the-next in parallel relation to each other.

In a particularly useful embodiment, a composite laminate comprises composite plies that contain E- and S-glass fibers respectively and that are oriented at angles of about 90° relative to one another in ply configuration.

An exemplary configuration for plies in a composite laminate having at least a first ply and a second ply is to have the second ply at 90° to the first ply. Other angles may also be chosen for desired properties with less than 90 degrees for the second sheet. Certain embodiments utilize a three sheet configuration wherein a first sheet is deemed to define a reference direction (i.e., zero degrees), a second sheet is disposed at a first angle (for example, a positive acute angle) relative to the first sheet (for example, about 45 degrees) and a third sheet is disposed at a second angle different from the first angle (for example, a negative acute angle) relative to the first sheet (that is, at an acute angle in an opposite angular direction from the second sheet (for example, about −45 degrees or, synonymously, at a reflex angle of about 315 degrees relative to the first sheet in the same direction as the second sheet). Thus the second and third sheets may or may not be perpendicular to each other. The thermoplastic matrix allows for easy relative motion of the fibers of adjacent plies during final molding of an article of manufacture.

According to further embodiments, at least two layers of composite plies of about the same areal density are arranged in a 0 to 90 degree configuration or, alternatively at angles from about 15 degrees to about 75 degrees. It is noted that the term “areal density” (typically expressed as pounds per square foot (lbs./sq. ft.)) can be employed to make comparisons of relative strength of different layer configurations. A higher areal density corresponds to a higher puncture strength of the layer. Also, composite laminates comprising at least two layers of composite plies, with the second layer having a greater areal density than the first layer, also are employed, according to embodiments. A non-limiting example of a suitable areal density for a composite laminate, according to embodiments, is about 1 to 10 lbs./sq. ft.

FIG. 3 schematically illustrates a non-limiting example of a composite laminate 200, which can be employed for at least one of the first outer layer (12), the second outer layer (14) and the intermediate layer(s) 17 of FIGS. 1 and 1A, according to embodiments, as well as employed for any desired composite article of construction, examples of which are described in further detail below. Composite laminate 200 comprises at least a first composite ply 220 and a second composite ply 240, according to embodiments. However, composite laminate could comprise any desired number of plies in configurations such as cross-ply, tri-ply, quad-ply, and so forth. As described above, according to embodiments, the thermoplastic matrix material of at least one ply comprises PVDF, and can also comprise polyethylene, and so forth. The composite plies 220 and 240 of this non-limiting example are each a unidirectional sheet or ply including longitudinally oriented fibers therein. Composite plies 220 and 240 can be separately produced in a continuous process and stored in individual rolls. A composite laminate as described herein, such as the exemplary composite laminate 200 illustrated in FIG. 3, comprises at least two composite plie bound together with their respective fibers in, e.g., transverse relation to each other. It is noted that any suitable thermoplastic material could be employed for one or more of these layers. Moreover, FIG. 3 illustrates a non-limiting example of one particular arrangement for various layers and it will be appreciated that the order and materials therefore could vary as desired. Thus, layers for plies 220 and 240 could be presented in any desired combination and order.

It is further noted that one or more additional layers could be employed in the construction shown in FIG. 3. For example, one or more layers of high strength fibers, e.g., commingled thermoplastic fibers, glass fibers, and so forth, could placed anywhere in the layup (e.g., between the layers and/or as outer layers of the construction) to function as, e.g., a structural layer. An example for the structural layer is to use a commingled laminate product. A suitable commercially available product for this layer is TWINTEX®, which is a registered trademark by Fiber Glass Industries. According to the manufacturer, TWINTEX® is a thermoplastic glass reinforcement (roving) made of commingled E-Glass and polypropylene filaments, which can be woven into highly conformable fabrics. Consolidation is completed by heating the roving above the melting temperature of the polypropylene matrix (180° C.-230° C.) and applying pressure before cooling under pressure. Examples of glass content include, by weight, 53%, 60% and 70%. Examples of the weave include plain and twill. The size and shape of the structural layer, as well as the other layers of FIGS. 1 and 1A, can be tailored as needed, depending upon the desired application.

It is further noted that, according to embodiments, the thermoplastic matrix material for the first outer layer (12), the second outer layer (14) and/or the intermediate layer (17) can further comprise a thermoset material, or combinations thereof. For example, the fibers as described above and in the amounts described above could also be incorporated in a thermoplastic/thermoset matrix material depending upon the desired application. Non-limiting examples of thermoset matrix materials include phenolics, polyesters, epoxides, combinations thereof, and so forth.

Regarding the methods of manufacture for the composite materials and structures disclosed herein, various methods may be employed. For example, various methods can be employed by which fibers in a ply may be impregnated with, and optionally encapsulated by, the matrix material, including, for example, a doctor blade process, lamination, pultrusion, extrusion, and so forth. It should be understood that other composite plies of composite laminates and other composite materials, composite laminates, panels and so forth described herein may also be produced by any suitable process, including those described herein, according to embodiments.

As a non-limiting example, a single laminate, a plied laminate and/or a “sandwiched panel” such as composite structure (10) can be produced from, e.g., unidirectional tapes, which can be produced in a variety of ways using, e.g., melt processes or power deposition methods. Multiply laminates are typically produced on a hydraulic or air pressurized press that has heating and cooling capabilities in a single molding. A particularly suitable method is to produce the material on a continuous belt press using Teflon. Steel belts can also be used with heat, pressure and cooling capabilities. Such methods can produce a continuous laminate that may be produced in rolls.

Moreover, sheets of the composite materials disclosed herein, according to embodiments, can be processes by compression molding to form complex shapes, such as aerospace interior panels either, e.g., as a multilayer sheet and/or in combination with core materials such as PVDF foam by Zotek, to form a structural composite panel. It is further noted that the laminates in various forms such as cross-ply, tri-ply, quad-ply, and so forth can be manufactured and used to wrap/wind or filament wind for pipes having increased structural properties, high corrosion resistance and/or fire resistance properties. Still further, such manufactured articles, including, e.g., the structural panel and pipes disclosed herein, according to embodiments, can also be used in the oil, gas and mining industries where corrosive, fire, smoke, and toxicity resistance, in combination with light weight and/or high strength structures are needed. Thus, it is noted that the composite materials disclosed herein are suitable for use in many industries and advantageously have diversified applications. For example, applications/structures of the composite materials disclosed herein and which are described in more detail below include, e.g., applications in the aerospace industry such as interior cabin area floors and walls of aircraft including coverings thereof, as well as other aircraft structures; rail car and bus applications/structures including floors, walls and coverings thereof; oil rig applications; specialty transportation applications including fire proof cargo containers; fire resistant/retardant armor and ballistic applications such as fire resistant/retardant ballistic composite panels, and so forth.

Additionally, embodiments disclosed herein can advantageously employ pre-impregnated (prepeg) thermoplastic materials comprising continuous reinforcing fibers impregnated with a thermoplastic matrix in a unidirectional tape, produced with by pultrusion or extrusion processing. In this regard, it is noted that in the case of, e.g., composite panels such as composite panel (10), a structure comprising multiple layers of the afore-referenced continuous fiber reinforced thermoplastic tape may be combined with expanded thermoplastic foam of the same, similar or different material exhibiting the desired properties.

With regard to the methods of manufacturing the composite materials and articles, disclosed herein, according to further embodiments, exemplary processing equipment suitable for making the fiber reinforced composite plies (e.g. first and second composite plies 220, 240 comprising, e.g., a plurality of fibers in a thermoplastic matrix described herein include a standard belt laminating system using coated belts, such as laminators commercially available from Maschinenfabrik Herbert Meyer GmbH located at Herbert-Meyer-Str., 1, D-92444 Roetz, Germany.

It is further noted that various other methods could be employed to, e.g., bond composite plies together to form a composite laminate in addition to, or as an alternative to the foregoing. Such methods include stacking the composite plies one on the next to form a composite laminate and applying heat and/or pressure, or using adhesives in the form of liquids, hot melts, reactive hot melts or films, epoxies, methylacrylates and urethanes to form the composite laminate panel. Sonic vibration welding and solvent bonding can also be employed. In general, a composite laminate can be constructed from a plurality of plies by piling a plurality of plies one on the next and subjecting the plies to heat and pressure, e.g., in a press, to melt adjacent plies together.

U.S. Pat. No. 8,201,608, assigned to the same assignee herewith, and the contents of which are hereby incorporated by reference, discloses suitable apparatuses and methods for making sheets of composite material. Such apparatuses and methods could be used to produce the composite laminates, materials and structures described herein.

Accordingly, reference below is made to such apparatuses and processes, with modification of some reference numerals and so forth for tailoring to the composite laminates and structures described herein.

An example of a suitable apparatus, which can be used to produce, e.g., a composite laminate 200 of FIG. 3, among other composite laminates and structures disclosed herein, is shown by the general block depiction of FIG. 4 and denoted by reference numeral 31. As shown in FIG. 3, apparatus 31 comprises an unwind station 32. During operation, composite material such as, e.g., a composite ply comprising a plurality of fibers in a thermoplastic matrix is fed or unwound from rolls in the unwind station 32 for further processing, according to embodiments. The apparatus 31 further includes a tacking station 34 adjacent to the unwind station 32, where additional layers of composite material can be tacked onto the composite material being unwound from the unwind station 32. These additional layers can be configured so that the fibers forming part of the additional layers of composite material can be oriented at different angles relative to the fibers in the composite material being unwound from the unwind station 32. However, embodiments are not limited in this regard, as the fibers forming part of the additional layers can also be oriented substantially parallel to the fibers forming part of the composite being unwound from the unwind station 32. The apparatus 31 includes an optional second unwind station 36 adjacent to the tacking station, where at least one additional layer of composite material can be unwound from rolls of composite material thereon. These layers can be unwound on top of the composite material unwound from the first unwind station 32 and any additional layers added at the tacking station 34. There is a heating station 38 downstream from the tacking station 34, where layers of composite material are heated so that they can bond to one another. There is also a processing station 40 downstream from the heating station 38. The processing station 40 includes at least one calender roll assembly 41, as explained in greater detail below. An uptake station 42 is positioned downstream of the processing station 40 for winding composite material laminate thereon. The overall progress of composite material from the unwind station 32 to the uptake station 42 is referred to herein as “the process direction,” indicated by the arrows in FIG. 4. The terms “upstream” and “downstream” are sometimes used herein to refer to directions or positions relative to the process direction.

It is noted that the particular shape, size and composition of a composite laminate, according to embodiments, can be tailored with use of the afore-described processing equipment, as desired. Once the desired composite laminate is constructed for, e.g., one, more than one, or all of the layers of the composite structure (10), the composite structure (10) can be assembled into the desired shape and construction, and the components bonded together.

Composite structure (10) and/or the composite laminates described herein and produced with use of, e.g., the foregoing apparatuses and processes, can be used in a wide variety of end use applications, especially cargo handling container components and cargo carrier applications, as well as building applications. In some embodiments, the composite structure (10) and/or composite laminates disclosed herein are configured for use as walls, liners, panels, flooring, containers and other structures in building and transportation applications, such as airplanes, cargo carriers including trailers, and so forth. For example, such materials can be used to fabricate panels, liners, containers, flooring, e.g., subfloors, doors, ceiling portions, wall portions and wall coverings, and so forth, of various sizes and strengths. It is further noted that particularly suitable embodiments include composite structures (10) and/or composite laminates disclosed herein configured for structural components and panels, liners, shipping containers, structural composites for aerospace applications, railcars, trucks, buses, and pipes that, e.g., require structural and/or corrosion resistance.

Different types of materials can be used alone or in combination with one another depending upon the desired application. Such articles as described herein can provide strong and durable structures, and so forth. More particularly, it has been determined that the composite structures (10) and/or composite laminates described herein can be configured as resultant end use products including, but not limited to, walls, doors, panels, liners, containers, ceiling portions, and so forth. Such articles exhibit advantageous properties in terms of, e.g., strength, light weight, corrosion resistance, flame retardance, smoke resistance, toxicity resistance, and so forth.

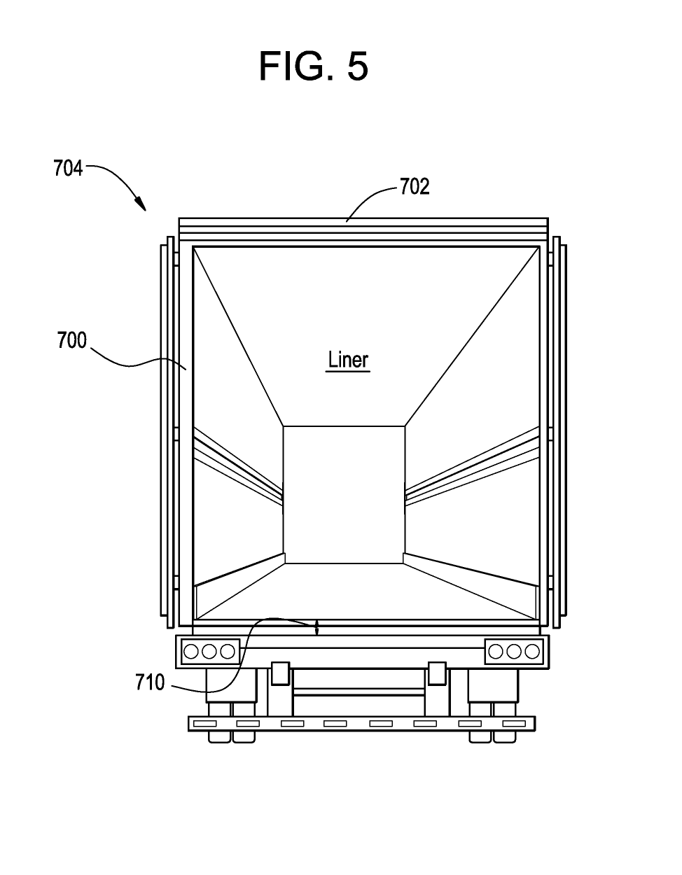

Further, non-limiting examples of particular end use products/applications for the composite structure (10) and/or composite laminates disclosed herein are set forth below. Referring to FIG. 5, the composite structure (10) and/or composite laminates disclosed herein can be used as, e.g., a liner for interior portions of over the road trailers or other transportation vehicles, vessels, containers, and so forth. FIG. 5 illustrates a liner 700 in the interior portion 702 of an exemplary over the road trailer 704. The liner 700, according to embodiments, can provide a composite panel exhibiting better properties than, e.g., standard chopped glass thermoset products. For example, liner 700 comprising polyethylene can be lighter and more cleanable, more stain resistant, and more abrasion resistant than some polypropylene based panels. Liner 700 can be located as an interior wall liner or wall covering, as well as a roof liner. Thus, liner 700 has applications for refrigerated containers (reefers), wall coverings, as well as other transport applications. Liner 700 can be configured as a durable, semi-rigid structure or panel specifically designed and formulated to improve thermal efficiencies in refrigerated containers such as reefers, according to embodiments.

In accordance with further embodiments and end use applications, and as illustrated in FIG. 5, the composite structure (10) and/or composite laminates disclosed herein can be configured as a panel 710 for a floor or subfloor of, e.g., a trailer or other vehicle, vessel, container and so forth. The panel 710 also can be covered with a coating, such as a durable flooring material also made from the composite materials and/or composite laminates disclosed herein, according to embodiments.

It is further noted that the embodiments disclosed herein can comprises the compositions and configurations in any combinations of the embodiments.

It should be further recognized that the composite laminates described herein in general, also are applicable to many types of cargo carriers, such as trailers, vans, delivery vehicles, rail cars, aircraft, ships, shipping containers used therein, and so forth. Additionally, it is the intent herein that the word “trailer” can include all such cargo carriers, and to use the words “shipping container” can thus include all shipping containers used therein.

Accordingly, in accordance with still further end use applications, while the composite structure (10) comprising composite laminates described herein have been described above, according to embodiments, as generally being configured as panels for over the road trailer truck applications, other applications are within the scope of embodiments described herein, such as, e.g., interior liners/panels configured for rail cars, interior liners/panels configured for aircrafts, interior liners/panels for containers, such as intermodal containers, building structures, pipes, and so forth.

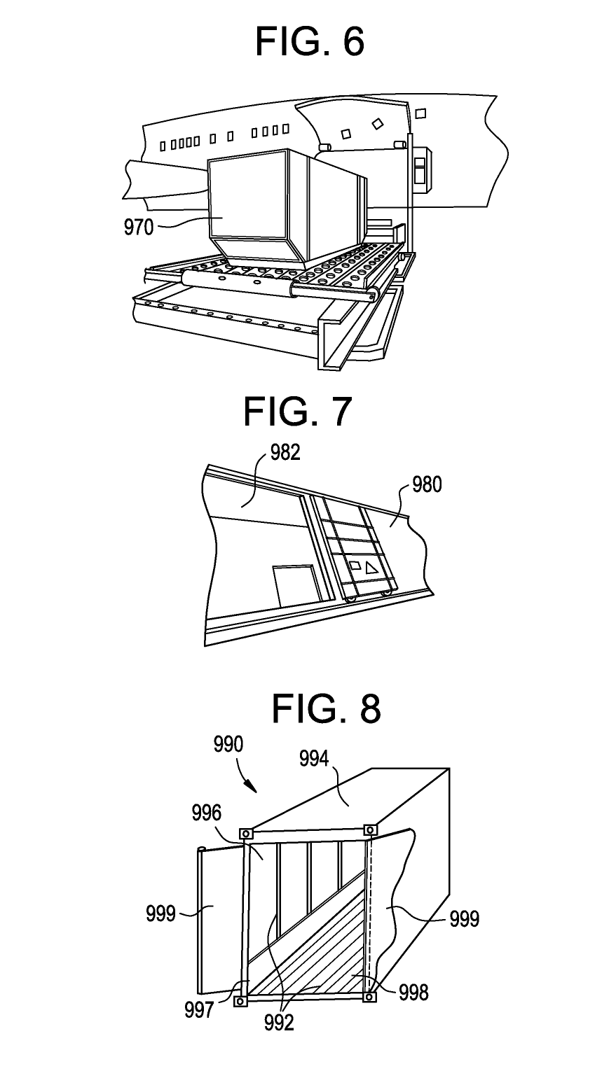

Moreover, structures such as the container itself also could be fabricated and/or refurbished using the composite materials, structures and laminates disclosed herein. As a non-limiting example of the foregoing, FIG. 6 illustrates a perspective view of an air cargo container 970, which can include a composite structure (10) and/or composite laminates as described herein, on an inner portion of the container 970, according to embodiments. The container 970 also could be made from the composite material and/or used for refurbishment, as explained above.

In accordance with further end use applications, FIG. 7 is a perspective view of a rail car 980 including a composite structure (10) and/or composite laminate as a liner 982, according to embodiments. The liner disclosed herein can be located at various locations of a container body such as on the interior portion of a rail car wall, among other locations.

FIG. 8 further illustrates a schematic perspective view of an intermodal container 990 including a composite structure (10) as a composite liner 992, according to embodiments. The intermodal container 990 comprises a roof portion 994, interior side walls 996, a floor 998 and door portion 999. As described herein, the liner according to embodiments, can be located at various locations of, e.g., a container or other structures. For example, as shown in FIG. 8, liner 992 can be located on floor 998 as a covering or integral therewith. Liner 992 also can be located on at least a portion of interior side walls 996, as well as be located on the interior portion of the roof portion 994. FIG. 8 further illustrates a scuff panel 997, which also can be made of and/or coated with the liner 992 described herein. It is further noted that the intermodal container 990 can be moved from one mode of transportation to another, such as from rail to ship to truck and so forth without the need to reload and unload the contents of the container. The size of the container 990 meets standard ISO requirements, according to embodiments. For example, the length can vary from 8 feet to 50 feet, and the height can vary from 8 feet to 9 feet, 6 inches.

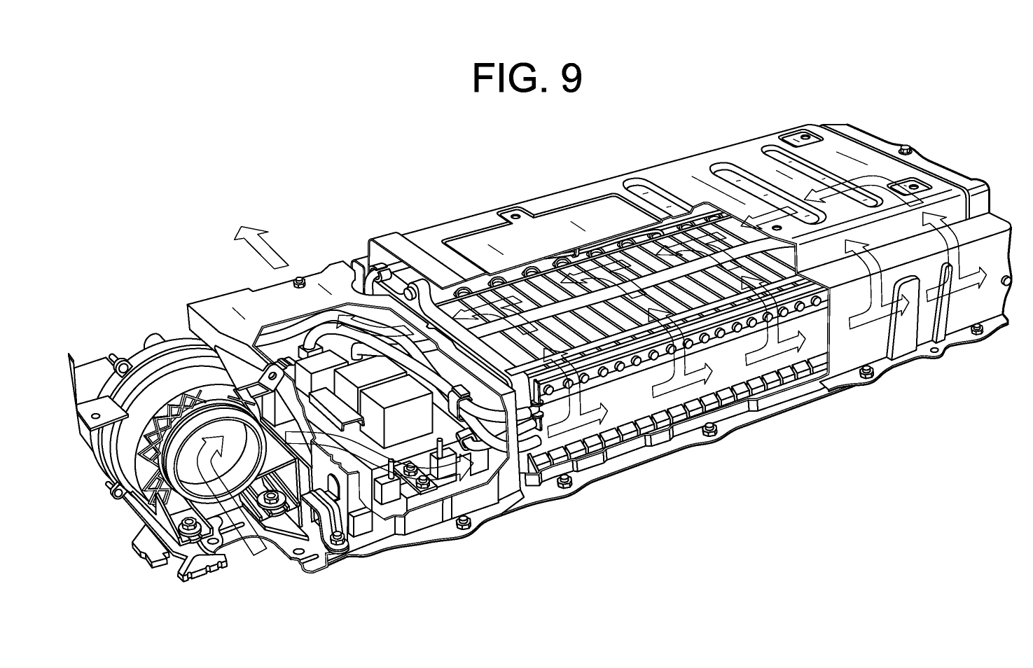

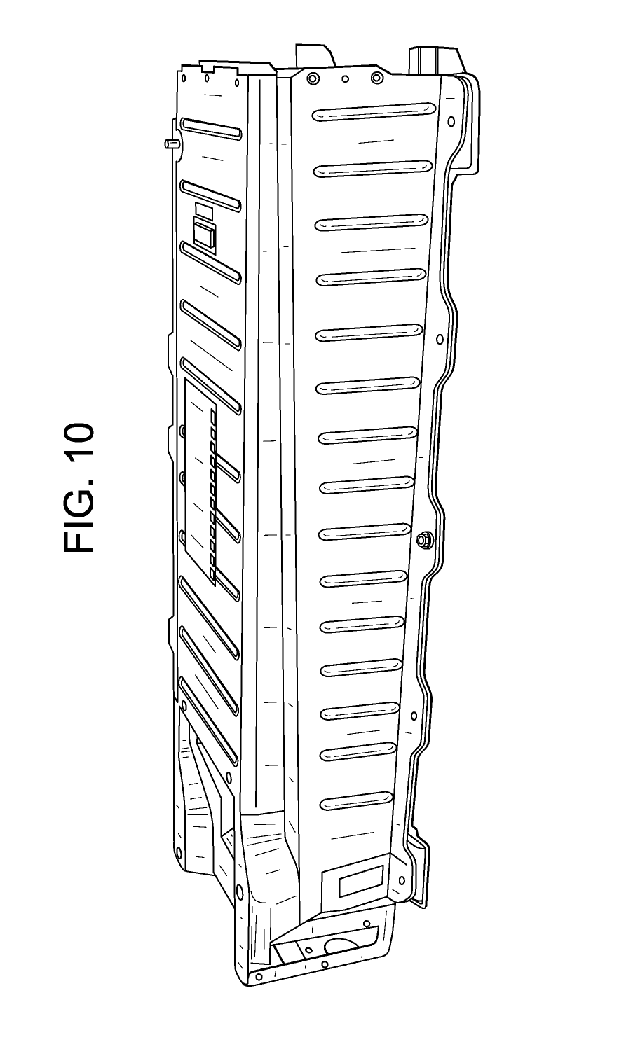

FIG. 9 illustrates another application for the composite structure (10) and/or composite laminates disclosed herein. In particular, FIG. 9 depicts a battery case comprising the composite structure (10) and/or composite laminate, according to embodiments. FIG. 10 illustrates a further application, specifically, a battery box comprising the composite structure (10) and/or laminate, according to embodiments.

It will be further appreciated that the composite structures (10) and/or composite laminates disclosed herein could be attached to structures, such as being attached to interior flooring, side walls, roofing, scuff plates, as well as other container portions. Similarly, entire or portions of, e.g., air cargo, rail and intermodal containers, pipes, and so forth, could be made from the composite structure (10) and/or composite laminates disclosed herein. Still further, the panels, liners and structures described herein also could be employed as part or all of an outer surface of the structures described herein such as trailers containers and so forth. In such cases, UV and/or wear resistance properties could be included in the structures. Refurbishment with use of the composite structure (10) and/or laminates, including panels, liners, and so forth, made therefrom are also included in embodiments.

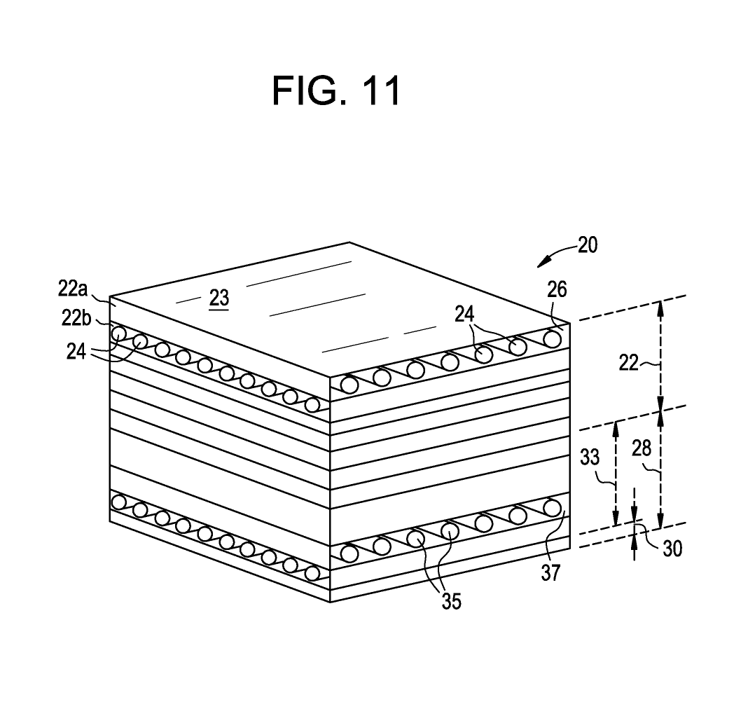

Moreover, as noted above, the embodiments disclosed herein are also applicable as armor or ballistic materials for, e.g., vehicles and personnel. For example, the embodiments disclosed herein can be used as fire retardant ballistic composites and panels. As non-limiting examples, the structures shown in, e.g., FIGS. 1, 3 and 11 could be employed as fire retardant composite ballistic panels. The ballistic materials and panels can be used to fabricate, e.g., fire retardant portable ballistic shields, such as a ballistic clipboard for use by a police officer, to provide fire retardant ballistic protection for fixed structures such as control rooms or guard stations, and to provide fire retardant ballistic protection for the occupants of vehicles, and so forth. In the illustrated embodiment of FIG. 11, a panel 20 comprises a strike face portion 22 that comprises a first plurality of plies 22a, 22b, etc. and that provides the strike face 23 of the panel. The plies in portion 22 are composite plies that comprise respective pluralities of a first kind of fibers 24 disposed in a first matrix material 26. The fibers 24 are substantially parallel to each other within each ply and, as illustrated by plies 22a and 22b, the plies are disposed so that the fibers in one ply are arranged crosswise to fibers in the adjacent ply, in this case, at 90° to each other. However, it will be appreciated that according to embodiments the arrangement can be at other suitable angles, e.g., less than 90°. Panel 20 also comprises a support portion 28 that comprise an optional back face stratum 30 and an internal portion 33. Internal portion 33 comprises a plurality of composite plies each comprising a second kind of fibers 35 in a second matrix material 37. Back face portion 30 comprises, e.g., a noncomposite ply of matrix material that is substantially free of fibers therein. In other embodiments, the number of plies and their composition can be varied depending on the application. Panel 20 may be produced by stacking cross plies of tape comprising the first type of fibers and cross plies of tape comprising the second kind of fibers and the noncomposite ply and pressing them together as described herein. For example, a panel may be constructed from a plurality of plies by piling a plurality of plies one on the next and subjecting the plies to heat and pressure, e.g., in a press to meld adjacent plies together.

In an embodiment, ballistic panel 20 has a strike-face portion principally comprising E-glass fibers as the lower-performing fibers and a support portion comprising S-glass fibers as the higher-performing fibers. Depending on the perfoimance criteria for a particular panel, the thickness of the panel and the relative thicknesses of the E-glass and S-glass portions of the panel can vary. Preferably, the S-glass plies and the E-glass plies are about equal in their weight contribution to the panel.

In specific embodiments, the E-glass fibers may comply with ASTM D578-98, paragraph 4.2.2, and may have a roving yield of about 250-675 yards/pound (yd/lb.), or a roving tex of about 735-1985 grams/kilometer (g/km). The S-glass fibers may comply with ASTM C 162-90 and/or ASM 3832B, and may comprise filaments of a diameter of about 9 micrometers, have a roving tex of 675-1600 g/km or a yield of about 310-735 yards/lb.

However, it is noted that the fibers described herein in any and all of the disclosed embodiments can be used for the afore-referenced fibers 24 and 35 and in any combination. Similarly, the composite materials described herein in any and all of the disclosed embodiments can be used for the plies of panel 20 and in any combination thereof.

The content of a composite ply may be stated in terms of the yield of the fiber used and the proportions of weight of the ply the fibers contributed by the fibers and the matrix material, respectively. For example, in an embodiment, a composite ply may comprise E-glass in a polypropylene matrix material. The fibers may have yield of about 56-1800 yards per pound of fiber, including about 675 yards per pound of fiber, and the fibers may comprise, e.g., about 40-92%, including 60-80%, of the ply, by weight of the fibers plus matrix material. The filament diameter may range, e.g., from about 0.005-0.025 microns. It is further noted that the matrix materials can include any and all matrix materials as described herein for the various disclosed embodiments and in any combination, and preferably comprise a fire retardant polymeric matrix material as described herein, e.g., comprising PVDF. Thus, the matrix materials described herein in any and all of the disclosed embodiments can be used for the first matrix material 26 and the second matrix material 37 and in any combination.

It is further noted that ballistic materials including panels can be tested in accordance with standards that evaluate their ability to withstand ballistic impact. Such standards, which are described briefly below, have been established by, e.g., the Department of Justice's National Institute of Justice entitled “NIJ Standard for Ballistic Resistant Protective Materials (‘NIJ Standard”). As the ballistic threat posed by a bullet or other projectile depends, e.g., on its composition, shape, caliber, mass and impact velocity, the NIJ Standard has classified the protection afforded by different armor grades as follows: Type II-A (Lower Velocity 357 Magnum and 9 mm), Type II (Higher Velocity 357 Magnum and 9 mm); Type III-A (44 Magnum, Submachine Gun and 9 mm), Type III (High-Powered Rifle), and Type IV (Armor-Piercing Rifle).

More particularly, Type II-A (Lower Velocity 357 Magnum and 9 mm): Armor classified as Type II-A protects against a standard test round in the form of a 357 Magnum jacketed soft point, with nominal masses of 10.2 g and measured velocities of 381+/−15 meters per second. Type II-A ballistic materials also protect against 9 mm full metal jacketed rounds with nominal masses of 8 g and measured velocities of 332+/−12 meters per second.

Type II (Higher Velocity 357 Magnum; 9 mm): This armor protects against projectiles akin to 357 Magnum jacketed soft point, with nominal masses of 10.2 g and measured velocities of 425+/−15 meters per second. Type II ballistic materials also protect against 9 mm full metal jacketed rounds with nominal masses of 8 g and measured velocities of 358+/−12 meters per second.

Type III-A (44 Magnum, Submachine Gun 9 mm): This armor provides protection against most handgun threats, as well as projectiles having characteristics similar 44 Magnum, lead semiwadcutter with gas checks, having nominal masses of 15.55 g and measured velocities of 426+/−15 meters per second. Type III-A ballistic material also protects against 9 mm submachine gun rounds. These bullets are 9 mm full metal jacketed with nominal masses of 8 g and measured velocities of 426+1-15 meters per second.

Type III (High Powered Rifle): This armor protects against 7.62 mm (308 Winchester®) ammunition and most handgun threats.

Type IV (Armor-Piercing Rifle): This armor protects against 30 caliber armor piercing rounds with nominal masses of 10.8 g and measured velocities of 868+/−15 meters per second.

In furtherance to the above, other tests for ballistic materials include the V₅₀ test as defined by MIL-STD-622, V₅₀ Ballistic Test for Armor. U.S. Pat. No. 7,598,185 further describes this test, and the contents of this patent are hereby incorporated by reference.

Advantageously, embodiments disclosed herein including fire retardant ballistic panels described herein may achieve at least one of the protection levels against a projectile as defined by the afore-referenced NIJ Standard Armor grades II-A, II, III-A, III and IV when the projectile is directed at the panel, as well as may pass the afore-referenced V₅₀ test.

Additionally, it should be appreciated that while the composite materials and/or laminates of, e.g., the composite structure (10) have been described in some embodiments as comprising, e.g., one or two plies, embodiments are not limited in this regard as any suitable multiple of plies (e.g., cross-ply, tri-ply, quad-ply, and so forth) could also be employed for any laminate of, e.g., the composite structure (10), the composition of which can vary depending on the intended end use application. As such, for example, structures, such as panels, liners, containers, and so forth, comprising a ply of less expensive lower performing E-Glass fibers in a thermoplastic matrix comprising polyethylene and a ply of more expensive, higher performing 5-Glass fibers also in a thermoplastic matrix comprising polyethylene can be fabricated.

According to embodiments, formation of a panel from plies comprising thermoplastic matrix materials to the substantial exclusion of thermosetting matrix materials can be achieved at lower pressure and for shorter periods than are needed for a thermosetting matrix material to cure. In addition, panels comprised of plies containing thermoplastic matrix material comprising polyethylene may require no degassing and generate little or no VOCs. Optionally, metals or ceramics or other materials can be added to a composite panel as described herein. Moreover, once fabricated, the panels and other structures described herein can be coated as desired, e.g., with a further composite, an elastomer, a metal housing etc. to protect against ultraviolet, moisture or other environmental influences. In addition, additives can be incorporated into the matrix material(s) for such things as fire resistance, smoke and toxicity resistance, and for cosmetic reasons.

Also, it will be appreciated that the final strength, stiffness, as well as other desirable properties, of the finished product depends, e.g., on the thermoplastic material(s) used, as well as the type, size, and orientation of the reinforcements and other materials employed. Moreover, the strength and stiffness of the final product is also dependent on, e.g., the overall dimensional shape of the finished product, including length, width, thickness, cross-sectional area, and so forth.

The teens “first,” “second,” and the like, herein do not denote any order, quantity, or importance, but rather are used to distinguish one element from another. In addition, the terms “a” and “an” herein do not denote a limitation of quantity, but rather denote the presence of at least one of the referenced item. When a numerical phrase includes the term “about” the phrase is intended to include, but not require, the precise numerical value stated in the phrase. Moreover, it is noted that features of any and/or all embodiments described herein could be combined in any combination with any and/or all features of other embodiments disclosed herein.

Although the invention has been described with reference to particular embodiments thereof, it will be understood by one of ordinary skill in the art, upon a reading and understanding of the foregoing disclosure, that numerous variations and alterations to the disclosed embodiments will fall within the spirit and scope of this invention and of the appended claims.

It is to be understood that the present invention is by no means limited to the particular construction herein disclosed and/or shown in the drawings, but also comprises any modifications or equivalents within the scope of the disclosure.

What is claimed is:

1. A fire resistant composite laminate comprising:
a thermoplastic matrix material reinforced with fibers embedded in the matrix of the composite laminate, wherein the thermoplastic matrix material of the fire resistant composite laminate comprises polyvinylidene fluoride (PVDF).

2. The fire resistant composite laminate of claim 1, wherein the fibers comprise fiberglass fibers.

3. The fire resistant composite laminate of claim 2, wherein the fiberglass fibers are selected from the group consisting of E-glass fibers, S-glass fibers, and a combination thereof.

4. The fire resistant composite laminate of claim 3, wherein the laminate comprises a plied construction or a tape construction.

5. The fire resistant composite laminate of claim 3, wherein the fibers are continuation fibers and the laminate comprises a tape construction.

6. The fire resistant composite laminate of claim 4, further comprising and additional reinforcing material.

7. A composite structure (10) comprising:
a first outer layer (12);
a second outer layer (14); and a
core (16) sandwiched between the first outer layer (12) and the second outer layer (14), wherein the core (16) comprises a foam; and
at least one of the first outer layer (12) and the second outer layer (14) comprises the fire resistant composite laminate of claim 1.

8. The composite structure (10) of claim 7, wherein the fire resistant composite laminate comprises a plurality of composite plies including at least a first composite ply and a second composite ply, the first composite ply and the second composite ply each comprising the fibers embedded in the thermoplastic matrix; the plurality of composite plies being bonded together to form the fire resistant composite laminate.

9. The composite structure (10) of claim 7, wherein at least one of the first outer layer (12) and the second outer layer (14) comprises a coating thereon.

10. The composite structure (10) of claim 7, wherein the fibers are substantially parallel to each other.

11. The composite structure (10) of claim 8, wherein the first composite ply and the second composite ply comprise fibers of different strength, and the first composite ply comprises E-glass fibers and the second composite ply comprises S-glass fibers.

12. A panel comprising the composite structure (10) of claim 7.

13. The composite structure (10) of claim 7, further comprising at least one intermediate layer (17) between the first outer layer (12) and the second outer layer (14).

14. The composite structure (10) of claim 13, wherein the core comprises expanded polyvinylidene fluoride (PVDF) foam at a thickness greater than the thickness of the first outer layer (12), the second outer layer (14) and the at least one intermediate layer (17).

15. A pipe comprising the fire resistant composite laminate of claim 1.

16. A pipe comprising the composite structure of claim 7.

17. A battery box comprising the composite structure of claim 7.

18. A battery case comprising the composite structure of claim 7.

19. A method of making the fire resistant composite laminate of claim 1, comprising forming the laminate into a unidirectional tape by melt processing.

20. The method of claim 19, further comprising bonding the laminate to a core, the core comprising polyvinlyidene fluoride (PVDF) foam.

21. A ballistic panel comprising the fire resistant composite laminate of claim 1.

22. A fire resistant composite laminate comprising:
a polymeric matrix material reinforced with fibers embedded in the matrix of the composite laminate, wherein the polymeric matrix material of the fire resistant composite laminate comprises at least one of polyvinylidene fluoride (PVDF), polyether ether ketone (PEEK), polyphenylene sulfide (PPS) and polyetheramide (PEI).

23. A fire retardant ballistic panel comprising the composite laminate of claim 22.

24. A fire retardant ballistic panel comprising:
a fire resistant composite laminate comprising:
a fire resistant polymeric matrix material reinforced with fibers embedded in the matrix of the composite laminate, wherein the fire retardant ballistic panel achieves at least one protection level against a projectile as defined by NIJ Standard Armor grades II-A, II, III and IV when the projectile is directed at the panel.

25. A fire retardant ballistic panel having a first face and a second face and comprising:
a strike face portion comprising a first plurality of plies each comprising fibers in a first polymeric matrix material comprising a first fire retardant resin; and
a support portion adjacent to the strike face portion, the support portion comprising a second plurality of plies each comprising fibers in a second polymeric matrix material comprising a second fire retardant resin, wherein each ply is bound to an adjacent ply.

26. The fire retardant ballistic panel of claim 25 wherein at least one of the first polymeric matrix material and the second polymeric matrix material comprises polyvinylidene fluoride (PVDF).

27. The fire retardant ballistic panel of claim 26 wherein the first plurality of plies comprises E-glass fibers and the second plurality of plies comprises S-glass fibers.

28. The fire retardant ballistic panel of claim 25 wherein the panel achieves at least one protection level against a projectile as defined by NIJ Standard Armor grades II-A, II, III-A, III and IV when the projectile is directed at the strike face.

29. The fire retardant ballistic panel of claim 26 wherein the fibers are substantially parallel to each other within their respective plies and wherein the plies are disposed so that fibers of each ply are disposed cross-wise to fibers of an adjacent ply.
